(19) United States
(12) Patent Application Publication
(10) Pub. No.: US 2005/0050492 A1
(43) Pub. Date: Mar. 3, 2005

(54) Systems and methods for performing circuit analysis on a circuit design

(76) Inventors: S. Brandon Keller, Evans, CO (US); Gregory Dennis Rogers, Fort Collins, CO (US); George Harold Robbert, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/647,605

(22) Filed: Aug. 25, 2003

(51) Int. Cl. G06F 9/45; G06F 17/50

(52) U.S. Cl. 716/5

(57) ABSTRACT

Methods, systems, software products perform circuit analysis on a circuit design. Instantiation paths for one or more design blocks of the circuit design are determined. Select information is recursively accumulated for each of the design blocks. Instantiation characteristics are applied to the accumulated information for each instance of the design blocks based upon instantiation hierarchy of the instance within the circuit design.

### RELATED APPLICATIONS

The present document contains material related to the material of copending, cofiled, U.S. patent application Ser. No. ______ Attorney Docket Number 100111221-1, entitled System And Method For Determining Wire Capacitance For A VLSI Circuit; Ser. No. ______ Attorney Docket Number 100111227-1, entitled System And Method For Determining Applicable Configuration Information For Use In Analysis Of A Computer Aided Design; Ser. No. ______ Attorney Docket Number 100111228-1, entitled Systems And Methods Utilizing Fast Analysis Information During Detailed Analysis Of A Circuit Design; Ser. No. ______ Attorney Docket Number 100111230-1, entitled Systems And Methods For Determining Activity Factors Of A Circuit Design; Ser. No. ______ Attorney Docket Number 100111232-1, entitled System And Method For Determining A Highest Level Signal Name In A Hierarchical VLSI Design; Ser. No. ______ Attorney Docket Number 100111233-1, entitled System And Method For Determining Connectivity Of Nets In A Hierarchical Circuit Design; Ser. No. ______ Attorney Docket Number 100111234-1, entitled System And Method Analyzing Design Elements In Computer Aided Design Tools; Ser. No. ______ Attorney Docket Number 100111235-1, entitled System And Method For Determining Unmatched Design Elements In A Computer-Automated Design; Ser. No. ______ Attorney Docket Number 100111236-1, entitled Computer Aided Design Systems And Methods With Reduced Memory Utilization; Ser. No. ______ Attorney Docket Number 100111238-1, entitled System And Method For Iteratively Traversing A Hierarchical Circuit Design; Ser. No. ______ Attorney Docket Number 100111257-1, entitled Systems And Methods For Establishing Data Model Consistency Of Computer Aided Design Tools; and Ser. No. ______ Attorney Docket Number 100111259-1, entitled Systems And Methods For Identifying Data Sources Associated With A Circuit Design, the disclosures of which are hereby incorporated herein by reference.

### BACKGROUND

An electronic computer aided design (“E-CAD”) package is utilized to construct a Very Large Scale Integration (“VLSI”) circuit design. The VLSI circuit design consists of a netlist that identifies electronic design elements (e.g., capacitors, transistors, resistors, etc.) and their interconnectivity (e.g., signal nets) within the VLSI circuit design. The VLSI circuit design is constructed from hierarchical design blocks (also known as cells) that provide specific functionality to the VLSI circuit design. Such design blocks may be re-used within the VLSI circuit design, or within other circuit designs. Designs blocks may be constructed from electronic design elements, nets and other design blocks, and may be re-used one or more times. Each use of a design block is called an “instance.”

A design engineer uses the E-CAD tool to analyze the VLSI circuit design during development. The E-CAD tool typically traces through instances of blocks used in the VLSI circuit design to sum certain information (e.g., FET size or wire width) and to apply instantiation-specific characteristics (e.g., switching frequencies and scaling factors) to the summation. During this analysis, the E-CAD tool therefore reprocesses and re-sums the information for each re-used block many times, each instance of the re-used block being individually processed. If the VLSI circuit design has billions of design elements, the analysis can take hours or even days of processing time to complete, resulting in lost productivity. Continuous lost productivity due to lengthy engineering development slows technology advancement and can result in significant costs, as well as lost business.

### SUMMARY OF THE INVENTION

In one embodiment, a method performs circuit analysis on a circuit design. Instantiation paths for one or more design blocks of the circuit design are determined. Select information is recursively accumulated for each of the design blocks. Instantiation characteristics are applied to the accumulated information for each instance of the design blocks based upon instantiation hierarchy of the instance within the circuit design.

In another embodiment, a system performs circuit analysis on a circuit design. One or more design blocks of the circuit design are selected through a user interface. An analysis tool determines instantiation paths for the design blocks, accumulates select information for each instance of each of the design blocks, and applies instantiation characteristics of each instance to the accumulated information. A memory stores the instantiation paths, the accumulated information, and results based upon the applied instantiation characteristics.

In another embodiment, a system performs circuit analysis on a circuit design, including: means for determining instantiation paths for one or more design blocks of the circuit design; means for recursively accumulating select information for each of the design blocks; and means for applying instantiation characteristics to the accumulated information for each instance of the design blocks based upon instantiation hierarchy of the instance within the circuit design.

In another embodiment, a software product has instructions, stored on computer-readable media, wherein the instructions, when executed by a computer, perform steps for performing circuit analysis on a circuit design, including:
instructions for determining instantiation paths for one or more design blocks of the circuit design; instructions for recursively accumulating select information for each of the design blocks; and instructions for applying instantiation characteristics to the accumulated information for each instance of the design blocks based upon instantiation hierarchy of the instance within the circuit design.

### BRIEF DESCRIPTION OF THE FIGURES

FIG. 1 illustrates one exemplary design block of a circuit design.

FIG. 2 illustrates one exemplary design block incorporating the design block of FIG. 1.

FIG. 3 illustrates one exemplary hierarchical circuit design.

FIG. 4 shows one system for performing circuit analysis on a circuit design.

FIG. 5 is an exemplary schematic diagram illustrating five design blocks.

FIG. 6 is a block diagram illustrating exemplary hierarchical instances of the design blocks of FIG. 3.

FIG. 7 is a schematic illustration of one layout view of the circuit design of FIG. 6.

FIG. 8 is a block diagram illustrating exemplary data flow during circuit analysis of a circuit design.

FIG. 9 is a flowchart illustrating one process for performing circuit analysis on a circuit design.

### DETAILED DESCRIPTION OF THE FIGURES

A signal net is a single electrical path in a circuit design that has the same electrical characteristics at all of its points. Any collection of wires that carries the same signal between design elements is a signal net. If the design elements allow the signal to pass through unaltered (as in the case of a terminal), then the signal net continues on subsequently connected wires. If, however, the design element modifies the signal (as in the case of a transistor or logic gate), then the signal net terminates at that design element and a signal new net begins on the other side. Connectivity in a circuit design is typically specified using a netlist, which indicates the specific nets that interconnect the various design elements.

A signal net may be divided into signal net ‘pieces’, each of which is part of a Highest Level Signal Name (“HLSN”). A HLSN is the unique signal name that identifies a collection of signal nets or ‘hierarchical signal net pieces’, which are the small pieces of intermediate wire (signal nets) in each hierarchical design block of a circuit design.

A significant characteristic of VLSI and other types of circuit design is a reliance on hierarchical description. A primary reason for using hierarchical description is to hide the vast amount of detail in a design. By reducing the distracting detail to a single object that is lower in the hierarchy, one can greatly simplify many E-CAD operations. For example, simulation, verification, design-rule checking, and layout constraints can all benefit from hierarchical representation, which makes them more computationally tractable. Since many circuit designs are too complicated to be easily considered in their totality, a complete design is often viewed as a collection of design element aggregates that are further divided into sub-aggregates in a recursive and hierarchical manner. In VLSI circuit design, these aggregates are commonly referred to as design blocks (or cells). The use of a design block at a given level of hierarchy is called an ‘instance’. Each design block has one or more ‘ports’, each of which provides a connection point between a signal net within the design block and a signal net external to the design block.

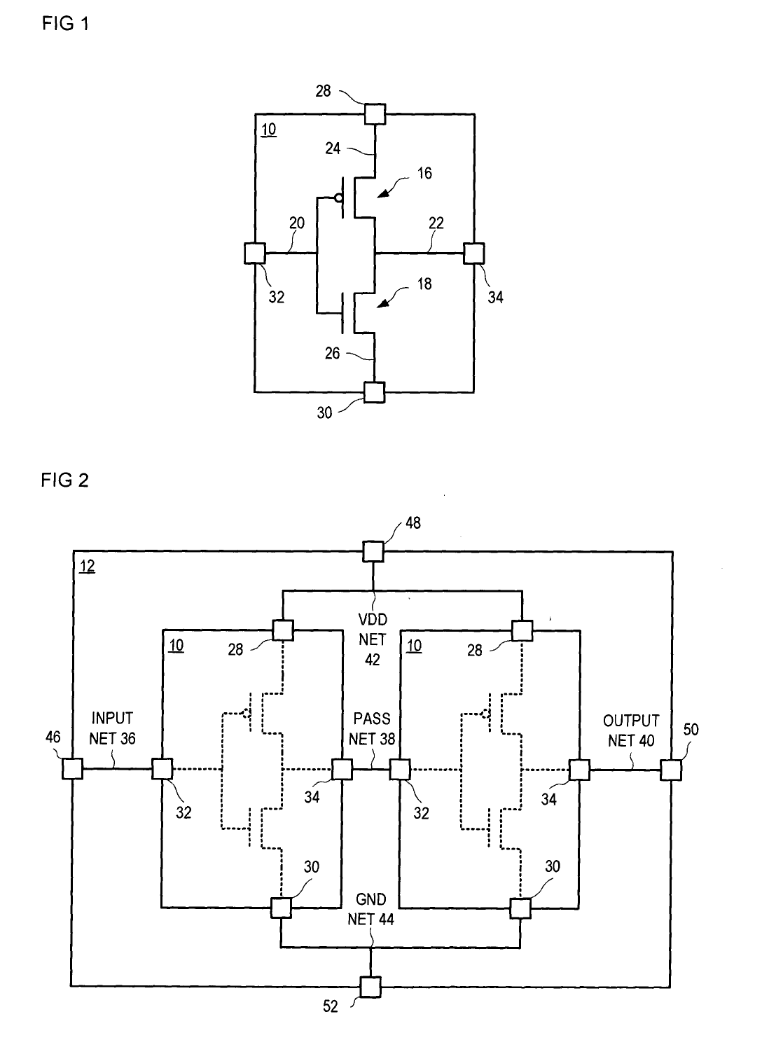

FIG. 1 shows one exemplary design block 10 suitable for use within a circuit design. Design block 10 has four ports 28, 30, 32 and 34 and, in this example, includes a p-type field-effect transistor (“FET”) 16 and an n-type FET 18 connected to form an inverter. Design block 10 also has four signal nets 20, 22, 24 and 26: signal net 20 connects to port 32; signal net 22 connects to port 34; signal net 24 connects to port 28; and signal net 26 connects to port 30. As shown in FIG. 2, design block 10 may be used within other design blocks to provide the inverter functionality, each use instantiating design block 10 within the circuit design.

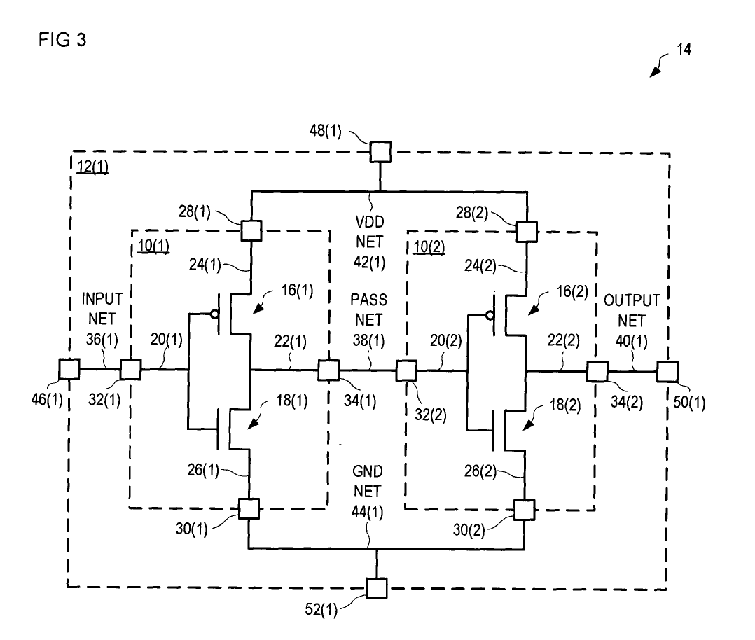

FIG. 2 shows another exemplary design block 12 that twice incorporates design block 10, FIG. 1. To illustrate exemplary nomenclature used in analyzing design block 12, design block 12 is shown with five signal nets; input net 36, pass net 38, output net 40, VDD net 42 and GND net 44. Design block 12 further includes ports 46, 48, 50 and 52 that connect internal signal nets 36, 42, 40 and 44, respectively, to signal nets external to design block 12. As shown in FIG. 3, design block 12 may also be instantiated within the circuit design.

FIG. 3 illustratively shows one hierarchical circuit design 14. Circuit design 14 incorporates design block 12, FIG. 2, as block instance 12(1), indicating a first “instance” of design block 12. Since design block 12 twice incorporates design block 10, FIG. 1, block instance 12(1) instantiates design block 10 as block instances 10(1) and 10(2). Block instance 12(1) also includes input net 36(1), pass net 38(1), output net 40(1), VDD net 42(1) and GND net 44(1). Block instance 10(1) includes FETs 16(1) and 18(1), signal nets 20(1), 22(1), 24(1), and 26(1), and ports 28(1), 30(1), 32(1), and 34(1). Block instance 10(2) includes FETs 16(2) and 18(2), signal nets 20(2), 22(2), 24(2), and 26(2), and ports 28(2), 30(2), 32(2), and 34(2). Signal nets 20(1) and 36(1) connect to port 32(1), forming hierarchical signal net pieces identified by HLSN “input net”. Signal nets 22(1), 38(1) and 20(2) interconnect by ports 34(1) and 32(2) and form hierarchical signal net pieces identified by HLSN “pass net”. Signal nets 24(1), 42(1) and 24(2) interconnect by ports 28(1) and 28(2) and form hierarchical signal net pieces identified by HLSN “VDD net”. Signal nets 26(1), 44(1) and 26(2) interconnect by ports 30(1) and 30(2) and form hierarchical signal net pieces identified by HLSN “GND net”. Signal nets 22(2) and 40(1) connect to port 34(2) and form hierarchical signal net pieces identified by HLSN “output net”.

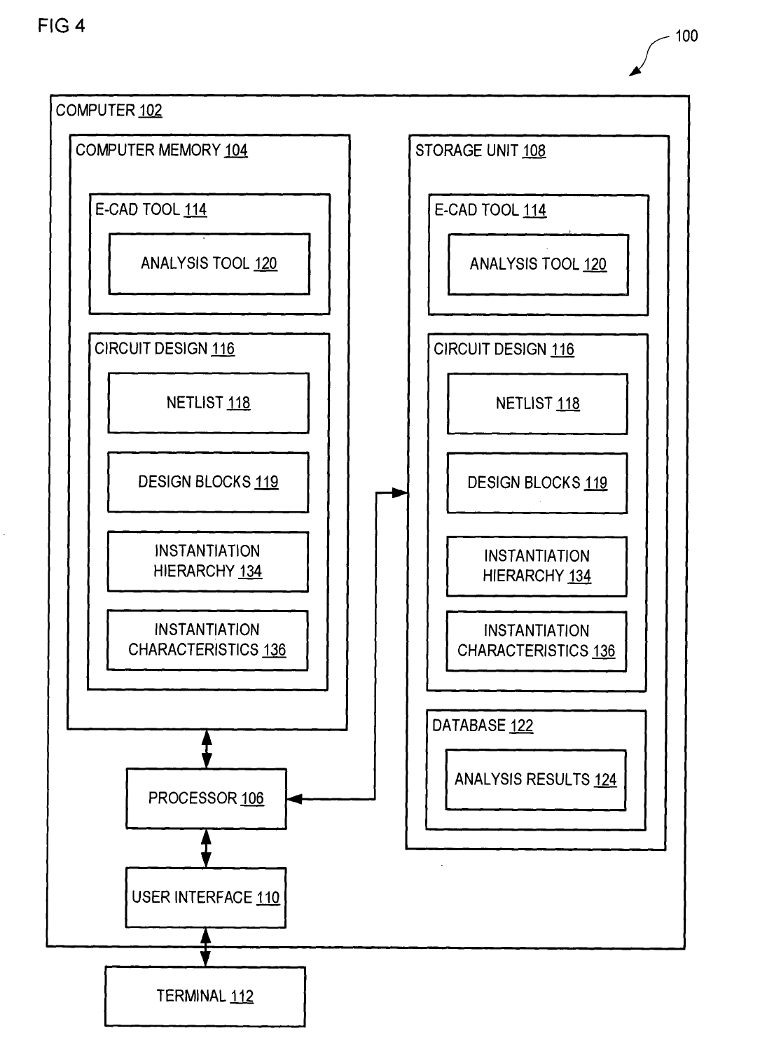

FIG. 4 is a block diagram illustrating one system 100 for performing circuit analysis on a circuit design (e.g., circuit design 14, FIG. 3). System 100 has a computer 102 with a computer memory 104, a processor 106, a storage unit 108 and a user interface 110. Storage unit 108 may for example be a disk drive that stores programs and data of computer 102. Storage unit 108 is illustratively shown storing an E-CAD tool 114, a circuit design 116 and a database 122. Circuit design 116 is, for example, a circuit design created by E-CAD tool 114. Circuit design 116 includes a netlist 118 that defines nets interconnecting various design elements of circuit design 116. In this example, circuit design 116 includes design blocks 119, an instantiation hierarchy 134 and instantiation characteristics 136, as shown. Instantiation hierarchy 134 defines specific instantiations of design blocks 119 within circuit design 116. Instantiation characteristics 136 store characterization information specific to each instantiation of a design block.

Processor 106 loads E-CAD tool 114, including an analysis tool 120, from storage unit 108 into computer memory 104 such that E-CAD tool 114 is executable by processor 106. Once loaded into computer memory 104, a design engineer operates E-CAD tool 114 to process and analyze circuit design 116, optionally storing results in database 122 as analysis results 124.

By way of example, user interface 110 connects to a terminal 112 (e.g., a keyboard), external to computer 102. Through terminal 112 and user interface 110, the design engineer interacts with E-CAD tool 114 and analysis tool 120. In one example, the design engineer instructs E-CAD tool 114 to analyze circuit design 116 using analysis tool 120, such as to perform power analysis on signal nets of circuit design 116.

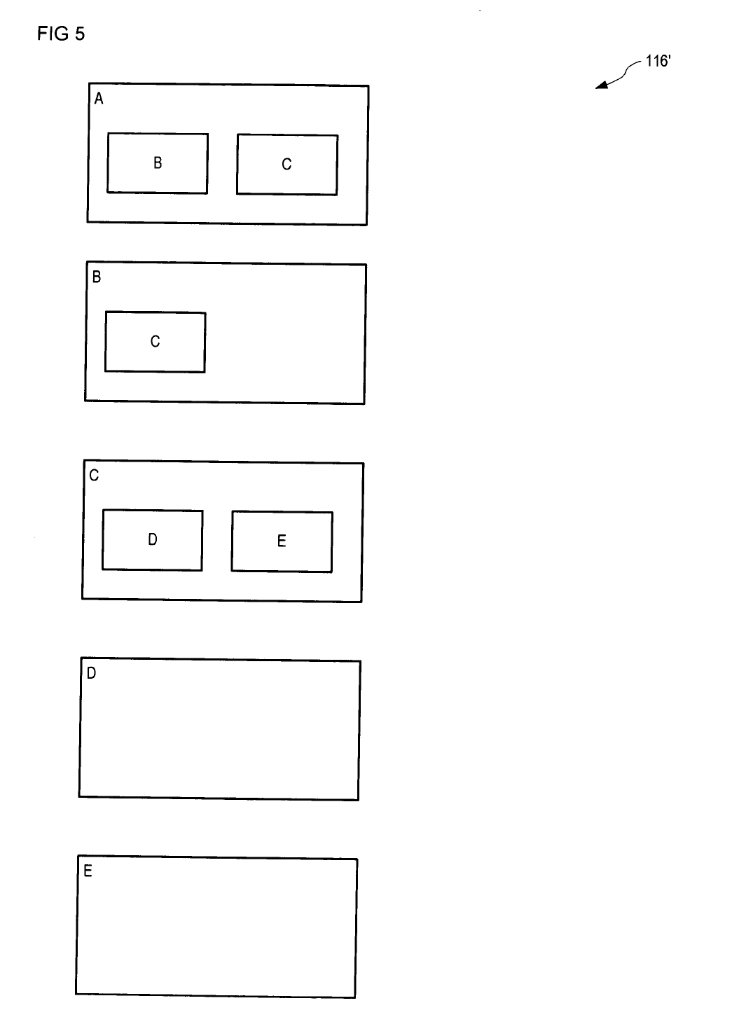

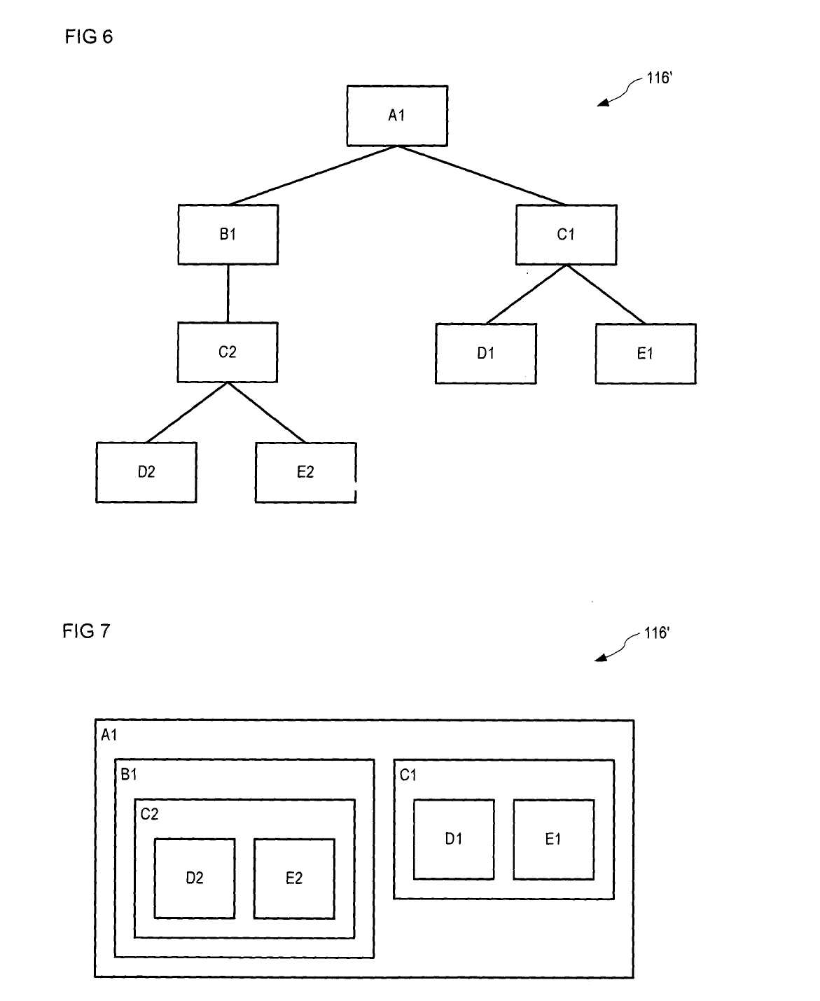

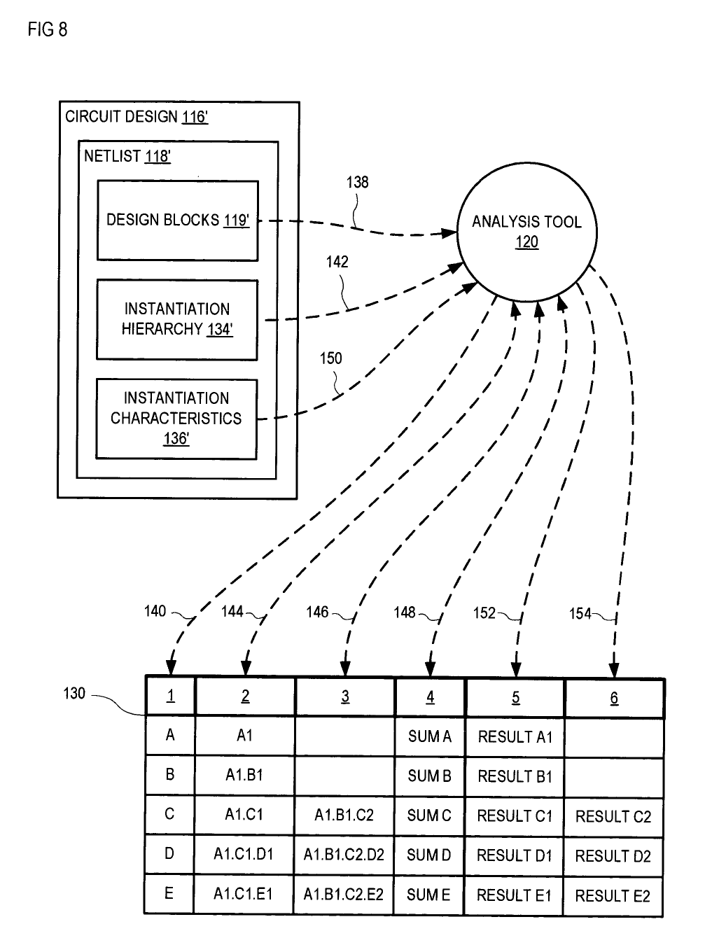

An exemplary circuit design 116′ is shown and described with five design blocks A-E in connection with FIG. 5, FIG. 6 and FIG. 7. FIG. 8 then illustrates one process of hierarchically traversing circuit design 116′ during circuit analysis. More particularly, the five design blocks A, B, C, D and E of FIG. 5 illustrate a hierarchical circuit design 116′, which may for example represent circuit design 116 of FIG. 4. Similar to design block 12, FIG. 2, which twice includes design block 10, design block A includes design blocks B and C; design block B includes design block C; and design block C includes design blocks D and E. Design blocks D and E do not incorporate other design blocks. Design elements are not shown within design blocks A, B, C, D and E for clarity of illustration. A design engineer defines design blocks A-E prior to instantiation within circuit design 116′.

FIG. 6 is a block diagram illustrating exemplary hierarchical instances of design blocks A, B, C, D and E of circuit design 116′. Design block A, FIG. 5, is the ‘top level block’ of circuit design 116′, and is instantiated in FIG. 6 as block instance ‘A1’, indicating that it is the first instance of block A. As design block A includes design blocks B and C, design blocks B and C are instantiated as block instances B1 and C1, as shown. Design block B includes design block C; thus a second instantiation of design block C is shown and identified as block instance C2. Design block C includes design blocks D and E; thus a first instantiation of design blocks D and E is shown and identified as block instances D1 and E1, relative to block instance C1. Second instantiations of design blocks D and E are shown as block instances D2 and E2, relative to block instance C2.

FIG. 7 illustrates how the instances of blocks A-E may exist in a layout view.

Accordingly, circuit design 116′ has five design blocks A, B, C, D and E, each instantiated one or more times, totaling eight instantiations A1, B1, C1, C2, D1, D2, E1 and E2. In one embodiment, analysis of circuit design 116′ is optimized by separating calculations specific to design blocks from calculations specific to instantiations. In this example, design block-specific calculations are determined for the five design blocks A-E, and instantiation-specific calculations are determined for the eight block instances A1, B1, C1, C2, D1, D2, E1 and E2.

The aforementioned calculations are for example performed by analysis tool 120, FIG. 4. With further reference to FIG. 4, the design engineer instructs analysis tool 120 to perform circuit analysis on one or more selected blocks of circuit design 116′, to analyze the entire circuit design or specific blocks of circuit design 116′. In one example, the design engineer instructs analysis tool 120 to analyze design blocks A-E of circuit design 116′; analysis tool 120 then processes the selected blocks, such as described in FIG. 8 below.

FIG. 8 is a block diagram illustrating exemplary data flow during circuit analysis of circuit design 116′. Analysis tool 120 first reads blocks A-E of design blocks 119′ of circuit design 116′ via a data path 138. Analysis tool 120 constructs a list of design blocks A-E in a first column 1 of a table 130. Analysis tool 120 then reads an instantiation hierarchy 134′ of circuit design 116′, via a data path 142, to determine instantiation path(s), if any, for each design block A-E of netlist 118′; analysis tool 120 then stores the paths in columns 2 and 3 of table 130 via data paths 144 and 146, respectively, as shown. The instantiation path(s) of columns 2, 3 identify each instantiation of design blocks A-E within circuit design 116′.

Analysis tool 120 next sums select, common information of design elements and signal nets of design blocks A-E. The summed information is illustratively stored in column 4 of table 130, via data path 148, as sum A, sum B, sum C, sum D and sum E. In one example, the design engineer using system 100, selects the common information as FET width and directs analysis tool 120 to sum the FET width information for column 4 of table 130. In another example, the design engineer selects the common information as wire capacitance and directs analysis tool 120 to sum the wire capacitance information for column 4 of table 130. In another example, the design engineer selects the common information as FET capacitance and directs analysis tool 120 to sum the FET capacitance information for column 4 of table 130.

Using the example of FIG. 1, FIG. 2 and FIG. 3, if analysis tool 120 is directed to analyze FET capacitance of circuit design 14, analysis tool 120 determines that design block 10 has two FETs and that design block 12 has four FETs. Analysis tool 120 then sums the FET capacitance for FETs of block 10 as one entry into column 4 of table 130, and stores the FET capacitance for FETS of block 12 as another entry into column 4 of table 130.

For each instantiation of design blocks A-E, identified by instantiation paths of columns 2 and 3 of table 130, analysis tool 120 reads associated information of instantiation characteristics 136′, via data path 150, and applies the information to column 4 to form instantiation-specific results. Instantiation-specific results (result A1, result B1, result C1, result C2, result D1, result D2, result E1, and result E2) are stored in columns 5 and 6 of table 130, as shown, for later reference or printing. Illustratively, instantiation characteristics may include switching frequencies and/or scaling factors.

In one embodiment, instantiation characteristics 136′ are applied to summed values of selected design blocks (e.g., design blocks A-E) to produce instantiation specific results (e.g., result A1, result B1, result C1, etc.) for each design block instantiation (e.g., A1, B1, C1, etc.) of the selected design blocks. For example, if block C is selected for analysis, analysis tool 120 uses instantiation hierarchy 134′, FIG. 6, to identify instances of block C within circuit design 116′ and applies instantiation characteristics 136′ to summed information of block C. Block instance C1 and block instance C2 may have different instantiation characteristics; these differences are therefore applied to the summed information (column 4) of block C. Accordingly, information of design block C (and recursively included design blocks) are summed only once and instantiation specific characterizations applied to the summed values for each instantiation (e.g., C1 and C2) of design block C, thereby reducing processing time required by analysis tool 120.

Upon reading and fully appreciating this disclosure, those of ordinary skill in the art appreciate that table 130 may exist in different form, with like function, without departing from the scope hereof. By way of example, in one embodiment table 130 is functionally replaced by data structures within analysis tool 120 or system 100, FIG. 4. Moreover, rows of table 130 may be specific to one or more selected HLSN signal nets (e.g., HLSN “input net”, HLSN “pass net”, etc.) of a circuit design. In one embodiment, therefore, analysis tool 120 recursively sums information of the selected HLSN signal nets within column 4 and then applies instantiation characteristics 136 to the summed properties based upon instantiation hierarchy 134, for columns 5, 6.

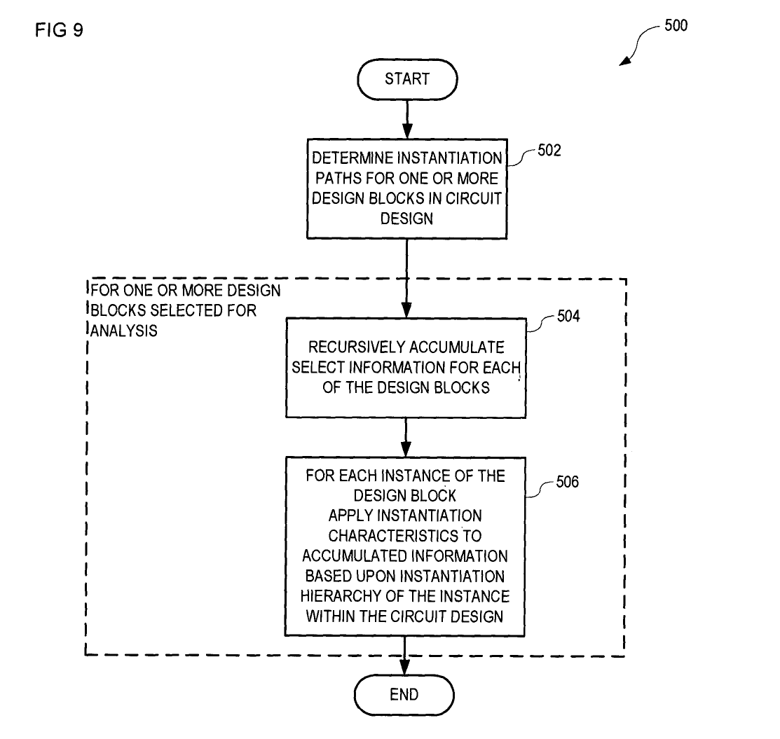

FIG. 9 is a flowchart illustrating one process 500 for performing circuit analysis on a hierarchical circuit design. For example, analysis tool 120 may implement process 500 to perform circuit analysis on circuit design 116. In step 502, process 500 determines instantiation paths for one or more design blocks, such as shown in table 130, FIG. 8. In step 504, process 500 recursively sums select information (e.g., FET width, wire capacitance and FET capacitance) for the design blocks. In one example, analysis tool 120 sums HLSN signal net properties within the design blocks, recursively tracing the HLSN signal net to sum the information. In step 506, instantiation characteristics 136′ for each instance of the design blocks are applied to the summed properties (of step 504) to calculate instantiation-specific results. For example, analysis tool 120 applies instantiation characteristics 136 (e.g., switching frequency and scaling factors) to instances (e.g., block instances A1, B1, C1, C2, D1, D2, E1 and E2) of selected design blocks (e.g., design blocks A, B, C, D and E) as identified by instantiation paths of table 130, FIG. 8. Analysis results from process 500 may be stored or printed.

Steps 504 through 506 are repeated for remaining selected design blocks of circuit design 116, as indicated.

Using the method described above, calculations (e.g., summation) are performed only once on each design block; instantiation characteristics are then applied to the calculated results once for each instance of the design block.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. A method for performing circuit analysis on a circuit design, comprising:
determining instantiation paths for one or more design blocks of the circuit design;
recursively accumulating select information for each of the design blocks; and
applying instantiation characteristics to the accumulated information for each instance of the design blocks based upon instantiation hierarchy of the instance within the circuit design.

2. The method of claim 1, the select information comprising one or more of FET capacitance, FET width and wire capacitance.

3. The method of claim 1, the instantiation characteristics comprising one or more of switching frequencies and scaling factors.

4. The method of claim 1, the step of recursively accumulating comprising recursively accumulating selected information for one or more HLSN signal nets within the design blocks.

5. The method of claim 4, further comprising selecting the one or more HLSNs through a user interface.

6. The method of claim 1, further comprising selecting the one or more blocks through a user interface.

7. The method of claim 1, further comprising reading instantiation hierarchy from the circuit design to determine the instantiation paths.

8. The method of claim 1, further comprising reading instantiation characteristics from the circuit design.

9. The method of claim 1, further comprising generating results based upon applied instantiation characteristics.

10. A system for performing circuit analysis on a circuit design, comprising:
a user interface for selecting one or more design blocks of the circuit design;
an analysis tool operable to determine instantiation paths for the design blocks, accumulate select information for each instance of each of the design blocks, and apply instantiation characteristics of each instance to the accumulated information; and
memory for storing the instantiation paths, the accumulated information, and results based upon the applied characteristics.

11. The system of claim 10, the select information comprising one or more of FET capacitance, FET width and wire capacitance.

12. The system of claim 10, the instantiation characteristics comprising one or more of switching frequencies and scaling factors.

13. The system of claim 10, the analysis tool operable to recursively accumulate the select information for one or more HLSN signal nets within the design blocks.

14. The system of claim 10, wherein the analysis tool is operable to read an instantiation hierarchy of the circuit design to determine the instantiation paths

15. The system of claim 14, wherein the analysis tool is operable to read the instantiation characteristics from the circuit design.

16. A system for performing circuit analysis on a circuit design, comprising:
means for determining instantiation paths for one or more design blocks of the circuit design;
means for recursively accumulating select information for each of the design blocks; and
means for applying instantiation characteristics to the accumulated information for each instance of the design blocks based upon instantiation hierarchy of the instance within the circuit design.

17. The system of claim 16, the select information comprising one or more of FET capacitance, FET width and wire capacitance.

18. The system of claim 16, the instantiation characteristics comprising one or more of switching frequencies and scaling factors.

19. The system of claim 16, the means for recursively accumulating comprising means for recursively accumulating select information of one or more HLSN signal nets of the design blocks.

20. The system of claim 16, further comprising means for reading instantiation hierarchy from the circuit design to determine the instantiation paths.

21. The system of claim 16, further comprising means for reading instantiation characteristics from the circuit design.

22. The system of claim 16, further comprising means for generating results based upon applied instantiation characteristics.

23. A software product comprising instructions, stored on computer-readable media, wherein the instructions, when executed by a computer, perform steps for performing circuit analysis on a circuit design, comprising:
instructions for determining instantiation paths for one or more design blocks of the circuit design;
instructions for recursively accumulating select information for each of the design blocks; and
instructions for applying instantiation characteristics to the accumulated information for each instance of the design blocks based upon instantiation hierarchy of the instance within the circuit design.

24. The software product of claim 23, the select information comprising one or more of FET capacitance, FET width and wire capacitance.

25. The software product of claim 23, the instantiation characteristics comprising one or more of switching frequencies and scaling factors.

26. The software product of claim 23, wherein the instructions for recursively accumulating comprise instructions for recursively accumulating the select information for one or more HLSN signal nets within the design blocks.

27. The software product of claim 23, further comprising instructions for reading instantiation hierarchy from the circuit design to determine the instantiation paths.

28. The software product of claim 23, further comprising instructions for reading instantiation characteristics from the circuit design.

29. The software product of claim 23, further comprising instructions for generating results based upon applied instantiation characteristics.
